(19) United States
(12) Patent Application Publication
(10) Pub. No.: US 2006/0251793 A1
(43) Pub. Date: Nov. 9, 2006

(54) High-quality human-grade ingredient dry pet food and method of producing same

(75) Inventor: Adelheid Irene Junger, San Diego, CA (US)

Correspondence Address: ADELHELD IRENE JUNGER, 4489 TEXAS STREET, SAN DIEGO, CA, 92116, US

(73) Assignee: Dr. Adelheid Irene Junger, San Diego, CA (US)

(21) Appl. No.: 10/908,272

(22) Filed: May 5, 2005

(51) Int. Cl. A23K 1/00

(52) U.S. Cl. 426/623

(57) ABSTRACT

A method is described for producing safe, minimally processed, dry pet foods with high natural nutrient values. This is achieved by avoidance of potentially harmful artificial additives or supplements, removal of potential contaminations, and by utilizing unprocessed or minimally processed, high-quality, all human-grade, and mostly organic, whole food ingredients, as well as a low-heat temperature drying process. During the low-heat drying process, the product (dough) is never exposed to temperatures exceeding 38° C. (100.4° F.). Such low-heat drying is believed to preserve more of the naturally occurring nutrients of the ingredients in the end product than is possible with conventional high-heat processing.

### CROSS REFERENCES

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT APPENDIX

Not Applicable

### BACKGROUND OF THE INVENTION

This invention relates to a method of producing minimally processed dried pet food that contains no conventional preservatives. Unlike the high temperature drying methods employed in manufacturing more conventional pet foods, the method employed here involves the application of a low-heat drying process. The invention as described here also relates to the unique pet food produced according to this manufacturing process.

Conventional dry pet foods are mostly composed of low quality ingredients such as inferior meats, meat byproducts, and refined carbohydrates which are, per se, very low in nutritional value and are processed using high-heat drying, cooking, steaming or baking processes which further diminish the nutritional value of the end product.

Dry pet foods are commonly produced by heating a mixture that may include cereals, grains, meats, fats, vitamins, and minerals to temperatures well above 100° F. (38° C.) and, in some instances as high as 300° F. (149° C.) or more. For example, U.S. Pat. No. 4,020,187 describes a method of producing a dry pet food by heating a meat slurry to 160-170° F. (71-77° C.), followed by cooking a mixture of the heated and homogenized meat slurry with added cereals, minerals, and preservatives at temperatures ranging from 225° F. to 325° F. (107-163° C.). In another example, U.S. Pat. No. 5,397,587 describes the production of pasta-type food which requires preconditioning of a moist mixture at 100° F. (38° C.) or above, preferably at a range of 1900 to 210° F. (88-99° C.), followed by extrusion under pressure and at temperatures between 110° F. and 280° F. (43-138° C.). It is important to note that temperatures used for drying conventional pet food can be as high as 518° F. (270° C.; e.g., U.S. Pat. No. 5,268,187) or, in one instance, as high as 572° F. (300° C.; e.g., U.S. Pat. No. 6,495,176).

It has been argued that at temperatures higher than 105° F. (40.6° C.) the nutritional values of food are profoundly altered; proteins coagulate, enzymes denature, antioxidants and antioxidant enzymes degrade, sugars caramelize, fibers break down, and a high percentage of water-soluble vitamins (vitamins B and C) and lipid-soluble vitamins (vitamins A, D, E, and K) are lost.

Although conventional dry pet food producers often add isolated exogenous minerals and vitamins, the bioavailability of these additions has been increasingly questioned by veterinarians and health care professionals alike, who recommend nutrient intake through appropriate food consumption. Furthermore, the use of predominantly non-organic ingredients in dry foods may contribute to chronic animal diseases due to nutritional deficiencies in the diet and exposure to chemicals-such as residual herbicides and pesticides, growth hormones, antibiotics and other drugs—that have accumulated during the production of the ingredients. Most conventional dry pet foods also contain artificial flavors, colors and preservatives, some of which have been suspected, or in a few cases, shown, to cause health problems in the long run. Other sources of potentially harmful constituents of many conventional pet food products are animal “by-products” and animal “digests” or “meals.” Although the FDA regulates the admissible levels of potentially harmful constituents and toxins of these highly variable food components, the veterinary community and health-conscientious pet owners alike are becoming increasingly aware of the health risks these components pose, particularly from long-term consumption of food containing animal by-products, digests or meals. In contrast to the current U.S. regulations, under EU regulations, only materials derived from animals declared fit for human consumption following veterinary inspection may be used for the production of feeds (Regulation (EC) No. 1774/2002 of the European Parliament and of the Council of 3 Oct. 2002). The same regulation also bans intra-species recycling, so-called “cannibalism”, a practice which is still allowed in the U.S. Given the accumulating research data on so-called prion diseases (i.e. bovine spongiform encephalopathy, or “mad cow” disease, and Scabies), such practices incur both obvious and major inherent risks (Doherr, 2003; Fatzer & Vandevelde 1998; Hill & Collinge, 2003; Rapoport, 1997).

The few dry pet food producers who are using human-grade ingredients are also using supplemental “natural” preservatives such as ascorbic acid (or “buffered vitamin C”) and/or ∝-tocopherol (e.g., The Honest Kitchen, Flint River Ranch). However, even these “natural” preservatives have been shown in animal experiments to incur increased health risks, including tumorogenesis. Under certain conditions, ascorbic acid and ∝-tocopherol have been shown to work as pro-oxidants rather than as anti-oxidants. Yoshida et al. (1994) found that dietary ascorbate and sodium ascorbate supplements enhance fore-stomach carcinogenesis promotion in combination with sodium nitrite in drinking water. Ohsawa et al. (2003) showed that, in contrast to naturally occurring ascorbic acid in fruit juices, supplementation with pure dietary ascorbic acid enhanced the induction of stomach tumors when nitrite was present in the food. Sodium ascorbate administration has also been shown to promote urinary bladder carcinogenesis (Fukushima et al., 1983; Chen et al., 1999) and exacerbate UV-related skin carcinogenicity (D'Agostini et al., 2005). In contrast, published data supports the idea that high consumption of vitamin C-rich fruit and vegetables is probably not harmful. It has also been suggested that ∝-tocopherol can act as a pro-oxidant by way of its reduction of Cu(II) to Cu(I) (reviewed in Burkitt, 2001). ∝-tocopherol has been shown to increase the incidence of glandular atypical foci in the forestomach (Hirose et al., 1993), and combined administration of ∝-tocopherol with NaNO₂ was shown to both enhance development of forestomach tumors after tumor initiation and induce mild hyperplasia without prior carcinogen exposure (Miyauchi et al., 2002). Recent clinical studies have reported adverse effects of supplemental vitamin E (∝-tocopherol) that may be directly related to its hepatic metabolism (reviewed in Traber, 2004). These studies demonstrate that many exogenous vitamin supplements do not have the same preventative and/or therapeutic effects as their natural counterparts that are contained in fruits, legumes, and vegetables. Moreover, such supplements may even be harmful when combined with toxins in food or water, a circumstance which is likely to occur, especially when exogenous supplement-containing foods are consumed for prolonged periods.

The use of whole grain products and other generally low glycemic index whole foods in pet food, as described in this application, reflects an increased awareness of the important health advantages that can be realized through the consumption of these foods instead of their more commonly consumed processed and refined counterparts. Consumption of low glycemic index diets and increased whole-grain intake have been associated with the prevention and in some cases even the treatment of chronic diseases, such as diabetes, cardiovascular disease, several kinds of cancers and obesity in humans (Jenkins et al., 2002; Slavin, 2004), all of which have become prominent health problems for pets in industrial countries as well.

From the foregoing, it is apparent that there is a profound need for safe, high-quality dry pet food that contains superior levels of biologically active nutrients, such as antioxidants, enzymes, fibers, vitamins and minerals. The low-heat drying process described in this application preserves the potency of naturally occurring nutrients contained in the high-quality, human-grade ingredients of the pet food to be manufactured. Whenever possible, organic ingredients will be used; in many cases, these have a higher level of nutrients and a lower risk of chemical contamination (Asami et al., 2003, Baker et al., 2002, Worthington 2001). Aside from the often higher vitamin, antioxidant and mineral content of organic produce, animal experiments also offer evidence of the beneficial heath effects of organically grown diet (Lauridsen et al., 2005). This indicates a positive effect of organically grown foods as compared to conventionally grown food. The use of high-quality, whole food ingredients, the omission of potentially harmful food additives and preservatives, and a low-heat drying process assure a food product that closely resembles the wholesome natural diet of small animals, including birds, herbivores (e.g., rabbits), omnivores (e.g., rodents such as guinea pig, rats, mice, hamsters), opportunistic carnivores (e.g., dogs), and obligate carnivores (e.g., ferrets, cats).

The manufacturing process described here yields products that contain a mixture of naturally occurring nutrients, antioxidants, enzymes, fibers, minerals and vitamins that are proposed to work in synergy. Such synergy is not likely to be achieved simply by adding and combining isolated nutrients and other supplements. Ingredients with high “functional” importance, such as whole grains, whole grain flours, “green supplements” like kelp and alfalfa, fruits and vegetables, probiotics, seeds, and food-based antioxidants will be used in the recipes to naturally enhance the nutritional value and stability of the food. To enhance palatability and usability of food for opportunistic or obligate carnivores, some recipes may contain a dietetically appropriate fraction of an animal-derived ingredient which has been processed at higher temperature before entering the described manufacture drying process (e.g., steamed organic muscle or organ meat or fish). Heating certain ingredients before introduction to the low-heat drying process may also be included in some pet food formulations if such pre-heating has been shown to increase a desired nutritional effect or remove toxic components that might occur naturally in certain plant matter.

The described drying process is novel to the dry pet food industry. This drying process—in combination with the exclusive use of human-grade, predominantly organic, whole food ingredients including the addition of “green supplements”, and the exclusion of potentially harmful ingredients (e.g., artificial flavoring, animal by-products or digests, or even the use of “natural” preservatives such as the myriad versions of supplemental vitamins C and E) make the resulting minimally processed products uniquely different from, and most likely superior to, other dry pet foods. Furthermore, the removal of potential contaminants from selected ingredients through exposure to ozone is a novel innovation in the pet food manufacture.

### BRIEF SUMMARY OF THE INVENTION

This invention relates to a method of producing minimally processed dried pet food that contains no conventional preservatives. Unlike the high temperature drying methods employed in manufacturing more conventional pet foods, the method employed here involves the application of a low-heat drying process. The invention as described here also relates to the unique pet food produced according to this manufacturing process. The resulting pet food has high levels of naturally occurring endogenous nutrients, antioxidants, enzymes, minerals, and vitamins. This is due to the exclusive use of high-quality human-grade, and predominantly organic, whole food ingredients that retain their nutritional and antioxidant potency throughout the manufacturing process.

The main objective of this invention is to produce high-quality, all human-grade, predominantly organic ingredient dry pet foods with high natural nutritional value and functionality, as well as provide a method of producing these foods.

Another objective of this invention is to avoid both potentially harmful chemicals and/or supplements and the addition of overly processed ingredients in the pet food in order to maintain health and to reduce the risk of chronic disease.

Yet another objective of this invention is to provide a line of high-quality dry pet foods that contains ingredients with specific functionalities and offers the consumer specialty foods to support specific organ systems of their pets.

These and other objects of this invention are accomplished by mixing high-quality, human-grade, mostly organic ingredients and processing the mixture via a low-heat drying process to produce a minimally processed, nutrient-rich dry food resembling natural food in its nutritional content.

### REFERENCES CITED

### US Patent Documents

U.S. Pat. No. 4,020,187 April, 1977 Method of producing dry pet food. McCulloch et al.
U.S. Pat. No. 5,397,587 March, 1995 Moist pasta-type food products and method of producing same. Thompson, et al.
U.S. Pat. No. 5,268,187 December, 1993 Method and apparatus for producing thin sheets of starch containing food material. Quinlan.
U.S. Pat. No. 6,495,176 December, 2002 Animal food composition. McGenity, et al.

### Other References

Asami D K, Hong Y J, Barrett D M, Mitchell A E (2003) Comparison of the total phenolic and ascorbic acid content of freeze-dried and air-dried marionberry, strawberry, and corn grown using conventional, organic, and sustainable agricultural practices. Journal of Agricultural and Food Chemistry 51(5): 1237-41.
Baker B P, Benbrook C M, Groth E 3rd, Lutz Benbrook K (2002) Pesticide residues in conventional, integrated pest management (IPM)-grown and organic foods: insights from three US data sets. Food Additives and Contaminants 19(5): 427-46.
Burkitt M J (2001) A critical overview of the chemistry of copper-dependent low density lipoprotein oxidation: roles of lipid hydroperoxides, alpha-tocopherol, thiols, and ceruloplasmin. Archives of Biochemistry and Biophysics 394(1): 117-35.
Chen T X, Wanibuchi H, Wei M, Morimura K, Yamamoto S, Hayashi S, Fukushima S (1999) Concentration dependent promoting effects of sodium L-ascorbate with the same total dose in a rat two-stage urinary bladder carcinogenesis. Cancer Letters 146(1): 67-71.
Doherr M G (2003) Bovine spongiform encephalopathy (BSE)—infectious, contagious, zoonotic or production disease? Acta Veterinaria Scandinavica Supplement 98: 33-42.
D'Agostini F, Balanskyl R M, Camoirano A, De Flora S (2005) Modulation of light-induced skin tumors by N-acetylcysteine and/or ascorbic acid in hairless mice. Carcinogenesis 26(3): 657-664.
Fatzer R, Vandevelde M (1998) Transmissible spongiform encephalopathies in animals. Wiener Medizinische Wochenschrift 148(4): 78-85.
Fukushima S, Imaida K, Sakata T, Okamura T, Shibata M A, Ito N (1983) Promoting effects of sodium L-ascorbate on two-stage urinary bladder carcinogenesis in rats. Cancer Research 43: 4454-57.
Hill A F, Collinge J (2003) Subclinical prion infection in humans and animals. British Medical Bulletin 66: 161-170.
Hirose M, Yada H, Hakoi K, Takahashi S, Ito N (1993) Modification of carcinogenesis by alpha-tocopherol, t-butylhydroquinone, propyl gallate and butylated hydroxytoluene in a rat multi-organ carcinogenesis model. Carcinogenesis, 14: 2359-2364.
Jenkins D J, Kendall C W, Augustin L S, Franceschi S, Hamidi M, Marchie A, Jenkins A L, Axelsen M (2002) Glycemic index: overview of implications in health and disease. American Journal of Clinical Nutrition 76(1): 266S-73S.
Lauridsen C, Jorgensen H, Halekoh U, Porskjær Christensen L, Brandt K (2005) Organic diet enhanced the health of rats. DARCOF e news, Newsletter from Danish Research Centre for Organic Farming (1).
López-Varela S., González-Gross M., Marcos A. (2002) Functional foods and the immune system: a review. European Journal of Nutrition 56, Supplement 3: S29-S33.
Miyauchi M, Nakamura H, Furukawa F, Son H Y, Nishikawa A, Hirose M (2002) Promoting effects of combined antioxidant and sodium nitrite treatment on forestomach carcinogenesis in rats after initiation with N-methyl-N′-nitro-N-nitrosoguanidine. Cancer Letters 178(1): 19-24.
Ohsawa K, Nakagawa S Y, Kimura M, Shimada C, Tsuda S, Kabasawa K, Kawaguchi S, Sasaki Y F. (2003) Detection of in vivo genotoxicity of endogenously formed N-nitroso compounds and suppression by ascorbic acid, teas and fruit juices. Mutation Research 539 (1-2): 65-76.
Rapoport E, Shimshony A. (1997) Health hazards to the small ruminant population of the Middle East posed by the trade of sheep and goat meat. Reviews in Science and Technology 16(1): 57-64.
Regulation (EC) No. 1774/2002 of the European Parliament and of the Council of 3 Oct. 2002 laying down health rules concerning animal by-products not intended for human consumption.
Slavin J (2004) Whole grains and human health. Nutrition Research Reviews (2004)17: 99-110.
Traber M G (2004) Vitamin E, nuclear receptors and xenobiotic metabolism. Archives of Biochemistry and Biophysics 423(1): 6-11.
Worthington V (2001) Nutritional quality of organic versus conventional fruits, vegetables, and grains. Jorunal of Alternative and Complement Medicine 7(2): 161-73.
Yoshida Y, Hirose M, Takaba K, Kimura J, Ito N (1994) Induction and promotion of forestomach tumors by sodium nitrite in combination with ascorbic acid or sodium ascorbate in rats with or without N-methyl-N′-nitro-N-nitrosoguanidine pre-treatment. International Journal of Cancer. 56 (1): 124-8.

### DETAILED DESCRIPTION OF THE INVENTION

The present invention describes a low-heat process to be employed in the manufacture of a high quality dry pet food.

Dough Ingredients:

The human-grade ingredients of the dough will be:
One, or a combination of, organic, raw, fermented, soaked, or sprouted whole grains or flours, cracked or small whole grains or grain-like seeds (e.g., amaranth, barley, buckwheat, kalmut, maize, oats, rye, brown rice, semolina, teff, whole grain cereal, wild rice);
Organic “green supplements” (e.g., kelp, alfalfa, chlorella, spirulina powder);
A calcium source (e.g., dried organic eggshell, CaCO₃ powder);
A natural food preservative: A plant-derived preservative or a combination of several natural food preservatives (e.g., organic fruit juices, organic spices or herbs, garlic, vanillin, plant-based essential oils or herbal extracts such as rosemary, tea or olive extracts, ozonated food-grade oils, lecithin, bee-produced products, organic acids such as citric acid);
Water (distilled or preferably spring water).
Additional ingredients, which may vary depending on the formulation:
Supplements (e.g., added minerals and vitamins, as required by Federal government regulations for pet food to meet the nutritional levels established by the Association of American Feed Control Officials [AAFCO] and Center for Veterinary Medicine [CVM]);
Organic herbs, organic spices, herbal extracts, unprocessed or minimally processed plant-based products (e.g., ashwanganda root, astragalus, cinnamon, dandelion, hay, nettle, parsley or garlic, green tea extract, myco-, soy- or rice-based products);
Organic seeds (e.g., flax or sesame seeds);
Organic nuts or nut meals, dried, raw, or soaked (e.g., sunflower seeds, walnut or almonds);
Dried, fresh, or frozen organic flowers or fruits, their concentrates or extracts (e.g., apples, banana, blueberries, cranberries, raspberries, rosehips);
Dried, fresh, frozen, lightly steamed, or fermented organic vegetables (e.g., avocado, carrots, cucumber, mushrooms, tomatoes, tomato paste, sweet potatoes, soy beans);
Organic heat-pasteurized animal-derived components (e.g., egg and dairy products, meat, fish);
Fish- or plant-based oils (e.g. salmon, cod-liver, flax or hemp seed oil).

The selection and proportion of these ingredients will depend on the formulation and the species, age, and breed of animal for which the food is to be prepared. For example, foods for opportunistic and obligate carnivores will have a high animal protein content (up to 50% or 75% for dogs and cats, respectively) and smaller proportions of fruits, vegetables, and grains, whereas omnivore foods will have a broad base of grains, fruits, and vegetables with little or no fraction of animal protein; foods formulated for herbivores will contain no meats whatsoever. Specialty foods might, for example, include a higher percentage of “functional foods” (López-Varela et al., 2002), such as psyllium husks, to increase transition time and decrease caloric content for weight loss support, milk thistle or dandelion root powder to support liver function, and increased levels of vitamin C-containing plant matter to support the immune system.

All ingredients will be stored in a manner that ensures good preservation of nutrients and avoids contamination, e.g., whole grains, flours, and kelp will be stored in the refrigerator or freezer until used. Specific ingredients (e.g., grains, nuts, sprouts, meat) will be placed in ozonated air or liquid (e.g., water) to reduce contamination (e.g., by microorganisms). Duration of exposure to ozone will follow the recommendations of the ozone generator manufacturer. Whenever possible, flours (such as stone ground flours) will be used that have not been milled at high temperatures to avoid loss of nutrient potency during the milling process. To minimize the introduction of potential toxins from any residual herbicides and pesticides and to maximize nutritional value and potential health benefits, organic products will be used whenever possible. No animal by-products, digests, or artificial flavors, colors or chemical preservatives will be added.

Dough Preparation:

A dough will be produced by mixing ingredients in commercial grade mixing equipment with a sufficient amount of high-quality water or other liquid to produce either a dry, pasta-like dough which can be rolled out into several mm thick sheets (preferable 2-3 mm thickness) or a soft dough which can be pressed through die-plates of a biscuit maker/cookie press or the nozzles of a dessert decorator or any other similar baking or extrusion equipment. Rolled-out dough may be partially precut (“diecut”) to allow easy separation of smaller pieces from a large manufactured dried product piece, and division into various smaller shapes to allow packaging in product bags or boxes. However, dough pieces can be formed in any suitable conventional manner, such as by extrusion, sheeting, stamping, cutting, or molding.

Drying Process:

Dough pieces will be placed on drying racks of a food dehydrator or any other apparatus that allows drying at the appropriate temperature of <38° C. (100.4° F.) for 6-12 hrs. The drying process will continue for about 48-72 hrs at room temperature (approximately 22° C. or 72° F.) until the product is dry. Drying times at low-heat (<38° C.) or room temperature will be increased if thicker dough pieces are to be produced. The end product will have a moisture content of <15% and in most cases, below 10%. The dehydration process will continue for at least 1 week at 4° C. (39.2° F.) or below 0° C. (32° F.) before packaging in airtight plastic containers with or without outer end-consumer packages.

If desired, the finished product of the invention can be stored at 4° C. (39.2° F.) or below 0° C. (32° F.) to preserve its nutritional value for extended periods of time corresponding to the duration of freshness of whole grain flours, herbs and other ingredients under similar storage conditions. On the package label, low temperature storage (in refrigerator or freezer) of products containing animal-derived ingredients will be specifically recommended.

Recipe example yielding dry dough which can be rolled into sheets and then cut and dried:

| | | |
|---|---|---|
| 101 | g | Durum flour, whole wheat, organic |
| 2.5 | g | Alfalfa powder, organic |
| 2.5 | g | Kelp powder, organic |
| 1.0 | g | Cinnamon powder, organic |
| 0.1 | g | Eggshell powder (from organic eggs) |
| 0.1 | g | Citric acid |
| 58 | ml | Springwater |

Obviously, modifications of this invention are possible. It is understood, therefore, that this application is intended to cover any variations, uses or adaptations of the invention, as may be considered to be known or customary practice in the art to which the invention pertains. The scope of the present invention should, therefore, be determined only by the following claims.

What is claimed is:

1. A method for the production of dry pet treats and foods containing less than 15%-by-weight moisture and a high natural nutritional value provided by the high-quality, all human-grade ingredients contained therein, compromising the steps of:
A. Blending a mixture of organic whole grains or grain-like seeds, a calcium source, a natural preservative (e.g., organic acid, spices, herbs), and organic green supplements (e.g., kelp, spirulina) with a varied selection of organic fruits (and/or nuts and seeds), supplements (e.g., supplemental minerals and vitamins, as required by Federal regulations), and other organic ingredients of plant (e.g., vegetables) or animal origin (e.g., meat), and a sufficient amount of high-quality drinking water to produce a dough; prior to blending, some ingredients (e.g., grains, nuts, sprouts or meat) will be placed in ozonated air or liquid to reduce contamination (e.g., by microorganisms) for periods recommended by the ozone generator manufacturer;
C. Shaping this dough by low-pressure extrusion without heat-production through nozzles of different shapes or by means of stamping, molding, or by rolling into preferably 2-3 mm-thick flat dough sheets which are to be cut into smaller pieces;
B. Dehydrating said dough shapes using a low-heat temperature drying process: The dough pieces will be dried on a drying rack of a food dehydrator or any other appropriate drying equipment, at equal or less than 32-38° C. (89.6-100.4° F.) typically for 6-12 hours. Drying time will be equal to, or less than, 72 hours at room temperature (approximately 72° F. or 22° C.) to yield a dry food product having a moisture content of less than 15%. Dehydration will continue for at least 1 week at 4° C. (39.2° F.) or below 0° C. (32° F.) before packaging in airtight containers.

2. A product line of highly nutritious pet foods and treats composed exclusively of human-grade ingredients to be produced in accordance with the method described in claim 1.

3. A product line of pet food and treats as described in claim 2 to contain a greater proportion of “functional” ingredients to support specific organ systems.

4. A product line of pet foods for herbivores and omnivores as described in claim 2 with no, or low, percentages of previously heat-pasteurized, human-grade organic, animal-derived ingredients.

5. A product line of pet foods for carnivores as described in claim 2 with high percentages of previously heat-pasteurized, human-grade, organic animal-derived ingredients.

6. A product line of pet foods or treats as described in claim 2, where water is partially or completely replaced by organic plant-derived (e.g., leaf, fruit, vegetable) juices or extracts, or probiotic-containing organic yoghurt or kefir.

7. A product line of pet foods or treats as described in claim 3, where water is partially or completely replaced by organic plant-derived (e.g., leaf, fruit, vegetable) juices or extracts, or probiotic-containing organic yoghurt or kefir.

8. A product line of pet foods for herbivores and omnivores as described in claim 4, where water is partially or completely replaced by organic plant-derived (e.g., leaf, fruit, vegetable) juices or extracts, or probiotic-containing organic yoghurt-kefir mixture.

9. A product line of pet foods for carnivores as described in claim 5, where water is partially or completely substituted by organic plant-derived (e.g., leaf, fruit, vegetable) juices or extracts, or probiotic-containing organic yoghurt-kefir mixture.
